(19) United States
(12) Patent Application Publication
(10) Pub. No.: US 2026/0340869 A1
(43) Pub. Date: Oct. 29, 2026

(54) METHOD FOR PROCESSING AN IMAGE FRAME SEQUENCE, APPARATUS, COMPUTING DEVICE AND STORAGE MEDIUM

(71) Applicant: SHENZHEN TCL CREATIVE CLOUD TECHNOLOGY CO., LTD., Shenzhen, Guangdong (CN)

(72) Inventor: Ming LEI, Shenzhen (CN)

(73) Assignee: SHENZHEN TCL CREATIVE CLOUD TECHNOLOGY CO., LTD., Shenzhen, Guangdong (CN)

(21) Appl. No.: 19/119,763

(22) PCT Filed: Aug. 7, 2023
(86) PCT No.: PCT/CN2023/111458

§ 371 Date: Apr. 9, 2025

(30) Foreign Application Priority Data
Oct. 10, 2022 (CN) 202211237073.3

(51) Int. Cl. G06T 7/73; G06T 7/90

(52) U.S. Cl. CPC G06T 7/74; G06T 7/90; G06T 2207/10016; G06T 2207/10024

(57) ABSTRACT

The present disclosure introduces a method, apparatus, computing device and storage medium for processing an image frame sequence. According to the method, while the differential pixel between the target image frame and the reference image frame is calculated, the first differential block is updated by the target differential pixel. The distance between the updated first differential block and a second differential block is calculated. If the distance is less than a preset distance threshold, the first differential block can be combined with the second differential block in real time, which may improve the efficiency for drawing subsequent target image frames.

The present disclosure claims the priority of the Chinese patent application titled “METHOD FOR PROCESSING AN IMAGE FRAME SEQUENCE, APPARATUS, COMPUTING DEVICE AND STORAGE MEDIUM”, with application number 202211237073.3, submitted to the China National Intellectual Property Administration on Oct. 10, 2022, the entire content of which is incorporated herein by reference.

### TECHNICAL FIELD

The present disclosure relates to the field of artificial intelligence technology, and in particular to a method for processing an image frame sequence, apparatus, computing device and computer-readable storage medium (referred to as storage medium).

### BACKGROUND

In the existing storage technology for image frame sequence processing, the differential area between the image frames is usually found by comparing the two adjacent image frames. For storing the image frame sequence, it is possible to only store the previous image frame and a image block corresponding to the differential area of the subsequent image frame to reduce the file size of the image frame sequence.

However, when the image frame sequence is displayed, the image blocks in each differential area of the subsequent image frame need to be decoded one by one to render and cover onto the previous image frame. When the number of differential areas is large, the decoding and rendering operation of the differential area may require a lot of resources and time, resulting in a significant reduction in image processing efficiency.

### SUMMARY

Based on this, it is necessary to address the above technical problems and provide a method for processing an image frame sequence, apparatus, computing device and storage medium to improve the recognition accuracy on the size of the target object.

In a first aspect, the present disclosure provides a method for processing an image frame sequence. The method includes: obtaining a target image frame in the image frame sequence and a reference image frame corresponding to the target image frame; obtaining multiple differential pixels between the target image frame and the reference image frame in an order of differential operation steps; updating a first differential block in the target image frame based on a target differential pixel in a current step of the differential operation; generating a target differential block based on the first differential block and a second differential block when a distance value between the first differential block and the second differential block is less than a preset distance threshold, wherein the second differential block is a differential block different from the first differential block in the target image frame; and when the target differential pixel of the current step of the differential operation is a last differential pixel, storing the image frame sequence based on the target differential block.

In some embodiments of the present disclosure, the operation of updating the first differential block in the target image frame based on the target differential pixel in the current step of the differential operation includes: obtaining one or more historical differential block in the target image frame; when the target differential pixel does not belong to any of the one or more historical differential blocks, determining one of the one or more historical differential blocks whose distance from the target differential pixel is less than a preset distance threshold as the first differential block; and updating the first differential block based on the target differential pixel in the current step of the differential operation.

In some embodiments of the present disclosure, after the operation of obtaining the one or more historical differential blocks in the target image frame, the method further comprises: when the target differential pixel does not belong to any of the one or more historical differential blocks and a distance of each of the one or more historical blocks from the target differential pixel is larger than the preset distance threshold, generate the first differential block based on the target differential pixel.

In some embodiments of the present disclosure, after the operation of generating the target differential block based on the first differential block and the second differential block, the method further comprises: updating the first differential block with the target differential block; and proceeding to the generating the target differential block based on the first differential block and the second differential block when the distance value between the first differential block and the second differential block is less than the preset distance threshold.

In some embodiments of the present disclosure, the operation of obtaining the plurality of differential pixels between the target image frame and the reference image frame in the order of differential operation steps comprises: obtaining a first pixel data of the target image frame at a current coordinate and a second pixel data of the reference image frame at the current coordinate in the order of the differential operation steps; when the first pixel data and the second pixel data are different, determining a pixel at the current coordinate as a differential pixel.

In some embodiments of the present disclosure, the operation of obtaining the plurality of differential pixels between the target image frame and the reference image frame in the order of differential operation steps comprises: obtaining a first transparency parameter of the target image frame at a current coordinate and a second transparency parameter of the reference image frame at the current coordinate in the order of the differential operation steps; when one of the first transparency parameter and the second transparency parameter is greater than a preset transparency parameter and another one of the first transparency parameter and the second transparency parameter is less than or equal to the preset transparency parameter, determining a pixel at the current coordinate as a differential pixel; when both the first transparency parameter and the second transparency parameter are greater than the preset transparency parameter, obtaining a first RGB parameter of the target image frame at the current coordinate and a second RGB parameter of the reference image frame at the current coordinate; responsive to the first RGB parameter and the second RGB parameter being different, determining a pixel at the current coordinate as a differential pixel.

In some embodiments of the present disclosure, before the operation of obtaining the target image frame in the image frame sequence and the reference image frame corresponding to the target image frame, the method further comprises: obtaining an image width and an image height of the image frame sequence; determining a maximum value between the image width and the image height; and determining the preset distance threshold based on the maximum value.

In some embodiments of the present disclosure, the operation of storing the image frame sequence based on the target differential block comprises: generating a differential image information based on a position of an area of the target differential block within the target image frame and a size of the area; and storing the image frame sequence based on the differential image information and the reference image frame.

In a second aspect, the present disclosure provides an apparatus for processing a sequence of image frames. The apparatus includes: an image frame acquisition module, configured to obtain a target image frame in the image frame sequence and a reference image frame corresponding to the target image frame; a differential pixel acquisition module, configured to obtain a plurality of differential pixels between the target image frame and the reference image frame in an order of differential operation steps, and update a first differential block in the target image frame based on a target differential pixel in a current step of the differential operation; a differential block merging module, configured to generate a target differential block based on the first differential block and a second differential block when a distance value between the first differential block and the second differential block is less than a preset distance threshold, wherein the second differential block is a differential block different from the first differential block in the target image frame; and a frame sequence storage module, configured to store the image frame sequence based on the target differential block when the target differential pixel of the current step of the differential operation is a last differential pixel.

In a third aspect, the present disclosure further provides a computing device. The computing device includes: one or more processors; a memory; and one or more application programs, wherein the one or more application programs are stored in the memory and configured to be executed by the processor to implement the image frame sequence processing method.

In a fourth aspect, the present disclosure further provides a computer-readable storage medium, stored with a computer program; wherein the computer program is executed by a processor to implement operations of the method for processing the image frame sequence.

### Technical Effect

According to the above-described method, apparatus, computing device, and storage medium, the following operations can be performed: obtaining a target image frame in the image frame sequence and a reference image frame corresponding to the target image frame; obtaining multiple differential pixels between the target image frame and the reference image frame in an order of differential operation steps; updating a first differential block in the target image frame based on a target differential pixel in a current step of the differential operation; generating a target differential block based on the first differential block and a second differential block when a distance value between the first differential block and the second differential block is less than a preset distance threshold, wherein the second differential block is a differential block different from the first differential block in the target image frame; and when the target differential pixel of the current step of the differential operation is a last differential pixel, storing the image frame sequence based on the target differential block. According to this method, while the differential pixel between the target image frame and the reference image frame is calculated, the first differential block may be updated based on the target differential pixel corresponding to the current step of the differential operation. At the same time, the distance between the first differential block (which is updated based on the target differential pixel) and other second differential block is calculated. If the distance between the first differential block and the second differential block is less than a preset distance threshold, the first differential block and the second differential block may be combined, such that the time cost for process differential blocks within the target image frame can be reduced. Moreover, the number of the differential blocks within the target image frame can be effectively controlled, which may avoid resource and time consumption for decoding and rendering to many differential blocks within the target image frame. Therefore, the efficiency of subsequent processing operations for the target image frame may be improved.

### BRIEF DESCRIPTION OF THE DRAWINGS

In order to explain the technical solutions in embodiments of the present disclosure more clearly, the drawings needed in the description of the embodiments will be briefly introduced below. Obviously, the drawings in the following description are only some embodiments of the present disclosure. Those skilled in the art can also obtain other drawings based on these drawings without exerting creative efforts.

FIG. 1A is a schematic diagram of differential blocks in an image frame according to related art.

FIG. 1B is a schematic diagram for processing image frames based on the differential blocks according to related art.

FIG. 2 is a flowchart of a method for processing an image frame sequence according to an embodiment of the present disclosure.

FIG. 3 is a schematic diagram of several differential blocks in the target image frame according to an embodiment of the present disclosure.

FIG. 4 is a flowchart of a method for processing an image frame sequence according to another embodiment of the present disclosure.

FIG. 5 is a schematic diagram of several differential blocks in an image frame according to an embodiment of the present disclosure.

FIG. 6 is a schematic diagram for processing image frames based on the differential blocks according to an embodiment of the present disclosure.

FIG. 7 is a schematic diagram of an apparatus for processing an image frame sequence according to an embodiment of the present disclosure.

FIG. 8 is a schematic diagram of a computing device according to an embodiment of the present disclosure.

### DETAILED DESCRIPTION

The technical solutions in embodiments of the present disclosure will be clearly and completely described below with reference to the drawings in the embodiments of the present disclosure. Obviously, the described embodiments are only some of the embodiments of the present application, not all of the embodiments. Based on the embodiments of the present disclosure, all other embodiments obtained by those skilled in the art without creative efforts fall within the scope of protection of the present disclosure.

In the description of this application, the terms “first” and “second” are only used for descriptive purposes and cannot be understood as indicating or implying relative importance or implicitly indicating the number of indicated technical features. Thus, features defined as “first” and “second” may expressly or implicitly include one or more of the recited features. In the description of this application, “plurality” or “multiple” means two or more, unless otherwise expressly and specifically limited.

Within the description of the present application, the word “such as” or “for example” is used to mean “serving as an example, instance, or illustration.” Any embodiment described herein as “such as” or “for example” is not necessarily to be construed as preferred or advantageous over other embodiments. The following description is presented to enable any person skilled in the art to achieve and use schemes of the present disclosure. In the following description, details are set forth for the purpose of explanation. It is understood that one of ordinary skill in the art will recognize that the present disclosure may be practiced without these specific details. In other instances, well-known structures and processes have not been described in detail in order not to obscure the description of the present disclosure with unnecessary detail. Thus, the present disclosure is not intended to be limited to the embodiments shown but is to be accorded the widest scope consistent with the principles and features disclosed herein.

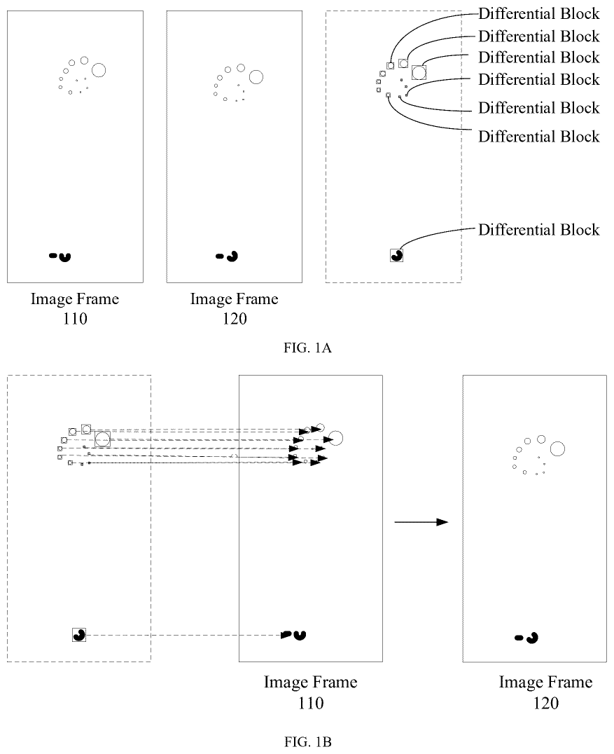

In the existing storage technology for image frame sequence processing, the differential area between the image frames is usually found by comparing the two adjacent image frames. For storing the image frame sequence, it is possible to only store the previous image frame and a image block corresponding to the differential area of the subsequent image frame to reduce the file size of the image frame sequence. Referring to FIG. 1A, the image frame 110 is the t-th image frame in the image frame sequence, and the image frame 120 is the image frame of the (t+1)-th frame in the image frame sequence. By comparing the two adjacent image frames, multiple differential areas between image frames can be found (only some of the differential areas are identified in the figure). As shown in FIG. 1A, compared with the image frame 120, the differential areas obtained by the differential operation is smaller. By storing the image frame sequence based on the differential areas, the file size of the image frame sequence may be significantly reduced.

However, assuming that the image frame sequence is an animation frame sequence similar to a starlight flickering effect, In this case, there are often a large number of pixels with changing brightness in the two adjacent image frames, and a large number of independent differential areas are formed accordingly. When storing the image frame sequence based on the differential areas, the file size of the image frame sequence may increase instead.

In addition, in the process of rendering the image frame 120, the image blocks corresponding to the differential areas need to be decoded one by one, drawn one by one, and overlaid onto the image frame 110. When there are many differential areas, a large number of decoding and drawing instructions need to be called, as shown in FIG. 1B, resulting in a significant reduction in processing efficiency.

Based on the above problems, a method for processing a sequence of image frames is provided according to an embodiment of the present disclosure. Specifically, while the differential pixel between the target image frame and the reference image frame is calculated, the first differential block may be updated based on the target differential pixel corresponding to the current step of the differential operation. At the same time, the distance between the first differential block (which is updated based on the target differential pixel) and other second differential block is calculated. If the distance between the first differential block and the second differential block is less than a preset distance threshold, the first differential block and the second differential block may be combined, such that the time cost for process differential blocks within the target image frame can be reduced. Moreover, the number of the differential blocks within the target image frame can be effectively controlled, which may avoid resource and time consumption for decoding and rendering to many differential blocks within the target image frame. Therefore, the efficiency of subsequent processing operations for the target image frame may be improved.

The image frame sequence processing method provided by embodiments of the present disclosure can be run on a terminal device or a server. The terminal device may be a local terminal device. The server can be an independent physical server, or a server cluster or distributed system composed of multiple physical servers, or it may be a cloud server capable of providing cloud services, cloud databases, cloud computing, cloud functions, cloud storage, network services, and cloud communications., middleware services, domain name services, security services, CDN, and cloud servers for basic cloud computing services such as big data and artificial intelligence platforms.

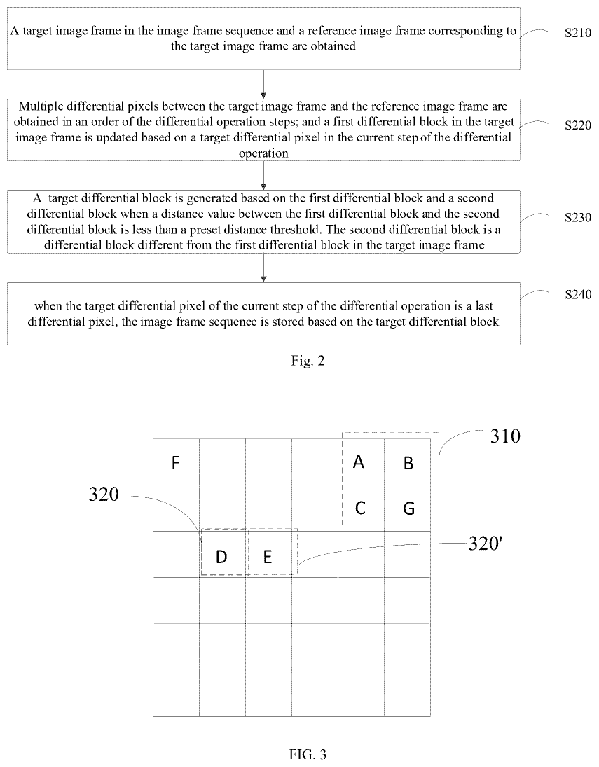

Referring to FIG. 2, an embodiment of the present disclosure provides a method for processing a sequence of image frames. The method applied to a server is taken as an example, which includes operations described in blocks S210 to S230.

In S210, a target image frame in the image frame sequence and a reference image frame corresponding to the target image frame are obtained.

Specifically, the image frame sequence may be video data, animation data, etc., and the image frame sequence includes multiple image frames that are consecutive in time series. The target image frame refers to an image frame to be processed in the image frame sequence, and the reference image frame is the adjacent and previous frame of the target image frame in time series. For example, the target image frame may be the image frame at the t-th time in the target frame sequence, and the reference image frame may be the image frame at the (t-1)-th time in the target frame sequence.

Specifically, after the image frame sequence to be processed is determined, each image frame may be determined as a target image frame one by one according to the order of the image frames in the image frame sequence, and a reference image frame corresponding to each target image frame is obtained.

In S220, multiple differential pixels between the target image frame and the reference image frame are obtained in an order of the differential operation steps; and a first differential block in the target image frame is updated based on a target differential pixel in the current step of the differential operation.

In one step of the differential operation, the terminal performs differential operation on the pixels at the same coordinate point between the target image frame and the reference image frame to determine whether the pixel at the coordinate point is a differential pixel. The order of the differential operation steps may be determined according to the arrangement order of pixels in the target image frame (or reference image frame). For example, FIG. 3 shows a schematic diagram of one target image frame consisting of 6 rows and 6 columns of pixels. The pixel F may be taken as the starting coordinate, and other pixels may be processed one row by one row. In each step of the differential operation, one coordinate is taken as the target coordinate of the current step of the differential operation. Pixel data in the target image frame and the reference image frame at the target coordinate may be compared to determine whether the pixel corresponding to the target coordinate is a differential pixel. For example, in a current step of differential operation, differential operation is performed between the pixel A in the target image frame and the pixel located at the first row and the fifth column of the reference image frame to determine whether the pixel located at the first row and the fifth column is a differential pixel. In a next step of differential operation, differential operation is performed between the pixel B which is located at the first row and the sixth column in the target image frame and the pixel located at the first row and the sixth column of the reference image frame to determine whether the pixel located at the first row and the sixth column is a differential pixel.

A differential block refers to a rectangular zone in the target image frame, in which one or more differential pixels exist in comparison with the reference image frame. Continuing with FIG. 3 as an example, pixel A, pixel B, pixel C and pixel D in the target image frame shown in FIG. 3 are differential pixels. Correspondingly, a differential block 310 may be defined based on the pixel A, pixel B, and pixel C in the target image frame. Another differential block 320 may be defined based on the pixel D in the target image frame. It should be understood, in comparison with the reference image frame, the target image frame may include one or more differential blocks. Herein, the first differential block refers to the differential block to which the target differential pixel obtained in the current step of differential operation should be added.

After the pixel corresponding to the coordinate that is processed in the current step of differential operation is determined as a differential pixel, the pixel corresponding to the coordinate may be determined as the target differential pixel. The first differential block corresponding to the target differential pixel may be determined from existing historical differential blocks of the target image frame. Alternatively, the first differential block may be acquired by generating a new differential block based on the coordinate location of the differential pixel.

Furthermore, after the first differential block corresponding to the target differential pixel is determined, the area location of the first differential block and the coordinate location of the differential pixel may be compared to determine whether the coordinate location of the differential pixel is within the area of the first differential block. If the coordinate location of the differential pixel is within the area of the first differential block, the area of the first differential block is kept unchanged when the differential pixel is included in the first differential block. If the coordinate location of the differential pixel is outside the area of the first differential block, the area of the first differential block needs to be changed when the differential pixel is included in the first differential block. Specifically, the area of the first differential block may be updated based on the coordinate location of the target differential pixel.

Continuing to refer to FIG. 3, for example, the pixel D shown in FIG. 3 is the target differential pixel obtained in the current step of differential operation. The first differential block may be acquired by generating a new differential block 320 based on the coordinate location of the pixel D. In the next step of differential operation, it is determined whether the pixel E is a differential pixel. When the pixel E is a differential pixel, the differential area 320 may be determined as the first differential area based on the pixel E, and area of the differential area 320 may be updated to include the pixel E in the differential area 320. Accordingly, area of the differential area 320 changes, which can be shown as the differential area 320′.

In S230, a target differential block is generated based on the first differential block and a second differential block when a distance value between the first differential block and the second differential block is less than a preset distance threshold. The second differential block is a differential block different from the first differential block in the target image frame.

In comparison with the reference image frame, the target image frame includes one or more differential blocks. After the first differential block is updated and acquired, the distance between the first differential block and a second differential block different from the first differential block in the target image frame may be calculated. Specifically, for any second differential block, the center coordinate of the first differential block may be acquired, and the center coordinate of the second differential block may be acquired. The distance value between the first differential block and the second differential block may be determined based on the distance between the center coordinate of the first differential block and the center coordinate of the second differential block. Alternatively, the shortest distance value between the boundary of the first differential block and the boundary of the second differential block may be acquired, and the shortest distance value may be determined as the distance value between the first differential block and the second differential block.

After the distance value between the first differential block and another differential block is acquired, the distance value may be compared with a preset distance threshold. If the distance value between the first differential block and a certain second differential block is less than the preset distance threshold, the first differential block and this second differential block may be combined to acquire the target differential block.

Moreover, in one embodiment, after the operation of generating the target differential block based on the first differential block and the second differential block, the method may further include: updating the first differential block with the target differential block (determining the target differential block as a new first differential block); and proceeding to the operation of generating the target differential block based on the first differential block and the second differential block when the distance value between the first differential block and the second differential block is less than the preset distance threshold.

When the first differential block and the second differential block are combined, area of the target differential block is changed. In other words, area of the target differential block is enlarged. The target differential block may be taken as the new first differential block, and the distance value between the new first differential block and a second differential block different from the new first differential block in the target image frame is calculated. Then, the second differential block with a distance to the new first differential block less than the preset distance threshold may be determined from other possible second differential blocks. The new first differential block may be combined with the determined second differential block to update the first differential block for another time, until the distance value between the first differential block and any other differential block in the target image frame is larger than or equal to the preset distance threshold.

It should be understood, when the distance value between the first differential block and any second differential block in the target image frame is larger than or equal to the preset distance threshold, the differential pixel of the next step of differential operation may be acquired based on the order of the steps of differential operation, and the above operations may be repeated. That is, the differential block may be updated again based on the differential pixel of the next step of differential operation. If the distance between the differential block updated based on the differential pixel corresponding to the next step of differential operation and another differential block is less than the preset distance threshold, the differential block updated based on the differential pixel corresponding to the next step of differential operation and the another differential block may be utilized to generate a target differential block, until the distance value between any two differential blocks in the target image frame is larger than or equal to the preset distance threshold.

In S240, when the target differential pixel of the current step of the differential operation is a last differential pixel, the image frame sequence is stored based on the target differential block.

The target differential block is the changing area(s) between the target image frame and the reference image frame. When the target differential pixel of the current step of the differential operation is the last differential pixel, the target differential block(s) and the reference image frame may be stored, and thus storage of the image frame sequence may be achieved.

In general, the above-described image frame sequence process method include: obtaining a target image frame in the image frame sequence and a reference image frame corresponding to the target image frame; obtaining multiple differential pixels between the target image frame and the reference image frame in an order of differential operation steps; updating a first differential block in the target image frame based on a target differential pixel in a current step of the differential operation; generating a target differential block based on the first differential block and a second differential block when a distance value between the first differential block and the second differential block is less than a preset distance threshold, wherein the second differential block is a differential block different from the first differential block in the target image frame; and when the target differential pixel of the current step of the differential operation is a last differential pixel, storing the image frame sequence based on the target differential block. While the differential pixel between the target image frame and the reference image frame is calculated, the first differential block may be updated based on the target differential pixel corresponding to the current step of the differential operation. At the same time, the distance between the first differential block (which is updated based on the target differential pixel) and other second differential block is calculated. If the distance between the first differential block and the second differential block is less than a preset distance threshold, the first differential block and the second differential block may be combined, such that the time cost for process differential blocks within the target image frame can be reduced. Moreover, the number of the differential blocks within the target image frame can be effectively controlled, which may avoid resource and time consumption for decoding and rendering to many differential blocks within the target image frame. Therefore, the efficiency of subsequent processing operations for the target image frame may be improved.

In some embodiments of the present disclosure, the operation of updating the first differential block in the target image frame based on the target differential pixel in the current step of the differential operation includes: obtaining one or more historical differential blocks in the target image frame; when the target differential pixel does not belong to any of the one or more historical differential blocks, determining one of the one or more historical differential blocks whose distance from the target differential pixel is less than a preset distance threshold as the first differential block; and update the first differential block based on the target differential pixel in the current step of the differential operation.

Herein, a historical differential block refers to an existing differential block in the target image frame. When the pixel that is processed in the current step of differential operation is determined as the differential pixel, the coordinate location of the target differential pixel corresponding to the current step of differential operation may be compared with an area location of a historical differential block, such that whether the target differential pixel is located in a certain differential block belonging to the historical differential blocks may be determined. When the target differential pixel is located within a certain differential block of the one or more historical differential blocks, the certain differential block may be determined as the first differential block corresponding to the target differential pixel of the current step of the differential operation. It should be understood, as the target differential block is within the first differential block, when the first differential area is updated based on the target differential block, the area of the first differential block remains unchanged. Continuing to refer to FIG. 3, for example, the pixel G as shown in FIG. 3 is the target differential pixel acquired in the current step of differential operation. The coordinate location of the pixel G corresponding to the current step of differential operation may be compared with an area location of a differential block 310, such that whether the pixel G is located in the differential block 310 may be determined. As the pixel G is within the differential block 310, the pixel G may be included in the differential block 310, and area of the differential block 310 remains unchanged.

When the target differential pixel does not belong to any of the one or more historical differential blocks, the distance value between the target differential pixel and each historical differential block may be calculated. Then the distance value between the target differential pixel and each historical differential block may be utilized to determine the differential block corresponding to the target differential pixel, and to acquire the first differential block. Specifically, when the distance value between the differential pixel and each historical differential block is determined, if there exists one differential block among the historical differential blocks whose distance value from the target differential pixel is less than a preset distance threshold, this differential block may be determined as the first differential block corresponding to the target differential pixel. Accordingly, the first differential block may be determined based on the target differential pixel. It should be understood, as the target differential block is within the first differential block, when the first differential area is updated based on the target differential block, the area of the first differential block may be enlarged.

In one embodiment, after the operation of obtaining the one or more historical differential blocks in the target image frame, the method further includes: when the target differential pixel does not belong to any of the one or more historical differential blocks and a distance of each of the one or more historical blocks from the target differential pixel is larger than the preset distance threshold, generate the first differential block based on the target differential pixel.

If there does not exist any differential block among the historical differential blocks whose distance from the target differential pixel is less than the preset distance threshold, the coordinate location of the target differential pixel may be acquired. A new differential block may be generated based on the coordinate location, and this differential block may be taken as the first differential block corresponding to the target differential pixel.

According to the present embodiment, it can be determined whether the target differential pixel that is processed in the current decoding step belongs to existing historical differential blocks. When the target differential pixel does not belong to any of the historical differential blocks, the distance value between the target differential pixel and each historical differential block may be utilized to determine the differential block which is updated based on the target differential pixel. In this way, while the differential pixel between the target image frame and the reference image frame is calculated, the differential block(s) in the target image frame may be updated based on the target differential pixel of the current step of differential operation in real time, which may facilitate subsequent combination operations for differential blocks in the target image frame. Thus, time consumption for processing the differential blocks in the target image frame may be reduced.

In one embodiment, the operation of obtaining multiple differential pixels between the target image frame and the reference image frame in an order of the differential operation steps may include: obtaining a first pixel data of the target image frame at a current coordinate and a second pixel data of the reference image frame at the current coordinate in the order of the differential operation steps; when the first pixel data and the second pixel data are different, determining a pixel at the current coordinate as a differential pixel.

The pixel data may refer to the color value of a pixel corresponding to a certain coordinate. Specifically, the pixel data may be a value in the color space, such as an RGB value in the RGB space or a YUV value in the YUV space.

The current target coordinate may refer to the target coordinate that is processed in the current step of differential operation.

Since the target image frame and the reference image frame are continuous in time series, the pixel data corresponding to the same coordinate in the target image frame and the reference image frame can be utilized to determine the differential pixel between the target image frame and the reference image frame. Specifically, the target coordinate that is processed in the current step of differential operation may be determined, and a first pixel data may be acquired from the current coordinate of the target image frame while a second pixel data may be acquired from the current coordinate of the reference image frame. Then, the pixel data at the target coordinate of the target image frame and the reference image frame may be compared. If the first pixel data is not identical to the second pixel data at the target coordinate, the pixel corresponding to the target coordinate may be determined as the differential pixel.

It should be understood, if both pixel data at the target coordinate is identical, the pixel corresponding to the target coordinate is not taken as the differential pixel. Then, the coordinate that should be processed in the next step of differential operation may be determined, and pixel data at the new coordinate in the target image frame and the reference image frame may be compared to determine whether the pixel corresponding to the next coordinate is a differential pixel.

By comparing the pixel data at the same coordinate, the differential pixel(s) between the target image frame and the reference image frame may be rapidly acquired, which facilitates generation of the differential block, and improve the storing efficiency of the image frame sequence.

Furthermore, pixel data may include a transparency parameter and an RGB parameter. Accordingly, the operation of obtaining the differential pixel between the target image frame and the reference image frame based on the sequence of steps of differential operation may include: obtaining a first transparency parameter of the target image frame at a current coordinate and a second transparency parameter of the reference image frame at the current coordinate in the order of the differential operation steps; when one of the first transparency parameter and the second transparency parameter is greater than a preset transparency parameter and another one of the first transparency parameter and the second transparency parameter is less than or equal to the preset transparency parameter, determining a pixel at the current coordinate as a differential pixel; when both the first transparency parameter and the second transparency parameter are greater than the preset transparency parameter, obtaining a first RGB parameter of the target image frame at the current coordinate and a second RGB parameter of the reference image frame at the current coordinate; responsive to the first RGB parameter and the second RGB parameter being different, determining a pixel at the current coordinate as a differential pixel.

The pixel data may refer to an RGB-A value of a pixel corresponding to a specific coordinate. That is, the pixel data may include the RGB parameter on the RGB channel and the transparency parameter on the alpha channel. It should be understood, when the transparency parameter of the alpha channel is 0%, the pixel corresponding to the target coordinate is a totally transparent pixel. In this case, regardless of the value of the RGB parameter on the RGB channel, the pixel appears as white. When the transparency parameter of the alpha channel is 100%, the pixel corresponding to the target coordinate is an opaque pixel. The pixel corresponding to the target coordinate appears as the color represented by the RGB parameter.

Specifically, the target coordinate that is processed in the current step of differential operation is determined. A first transparency parameter of the target image frame at a current coordinate and a second transparency parameter of the reference image frame at the current coordinate are obtained. Then, the transparency at the target coordinate may be determined based on the first transparency parameter and the second transparency parameter. Three different cases as follows may be considered.

Case 1: When both the first transparency parameter and the second transparency parameter are less than or equal to the preset transparency parameter, the pixels at the coordinate in both the target image frame and the reference image frame are transparent pixels. Thus, the displayed colors of the pixels at the target coordinate in both the target image frame and the reference image frame may be considered as identical, and the pixel at the target coordinate is not a differential pixel.

Case 2: When one of the first transparency parameter and the second transparency parameter is larger than the preset transparency parameter while the other is less than or equal to the preset transparency parameter, one of the pixels at the coordinate in the target image frame and the reference image frame is a transparent pixel while the other is an opaque pixel. Thus, the pixel corresponding to the target coordinate may be determined as a differential pixel.

Case 3: When both the first transparency parameter and the second transparency parameter are larger than the preset transparency parameter, neither of the pixels at the coordinate in the target image frame and the reference image frame is a transparent pixel. In this case, the RGB parameters at the target coordinate may be compared. If the first RGB parameter and the second RGB parameter at the target coordinate are not identical, the pixel corresponding to the target coordinate may be determined as a differential pixel.

The preset transparency parameter is utilized to determine whether the pixel at the current coordinate is a transparent pixel. When the transparency parameter of the pixel at the current coordinate is less than or equal to the preset transparency parameter, the pixel at the current coordinate may be considered as a transparent pixel. Specifically, the preset transparency parameter may be equal to zero. In addition, considering the existence of noise, the preset transparency parameter may be set to a substantially small value, such as 5. By comparing the transparency parameters of the pixels corresponding to the current coordinate, and then comparing the RGB parameters based on the transparency of the pixels corresponding to the current coordinate, the impact of existence of transparent pixels on determination of differential pixels is considered. Thus, the accuracy for determination of differential pixels may be improved. The chance where a transparent pixel is mistaken as a differential pixel which leads to enlargement of the differential block may be eliminated or reduced.

In one embodiment, before the operation of obtaining the target image frame in the image frame sequence and the reference image frame corresponding to the target image frame, the method further includes: obtaining an image width and an image height of the image frame sequence; determining a maximum value between the image width and the image height; and determining the preset distance threshold based on the maximum value.

The image width and the image height are configured to represent the image size of an image frame in the image frame sequence. When the image width and the image height of the image frame sequence are obtained, the image width and the image height may be compared. The larger value between the two values may be determined, and the preset distance threshold may be calculated based on the larger value.

Specifically, the preset distance threshold may be determined by dividing the maximum value by n to obtain the preset distance threshold; wherein n is an integer ranging from 5 to 10. In this way, the preset distance threshold is set according to the image width and the image height of the image frame sequence. Thus, cases where too many differential blocks in the target image frame are combined as one differential block due to an excessive distance threshold may be avoided, as well as cases where different differential blocks in the target image frame cannot be combined due to an insufficient distance threshold.

In one embodiment, the operation of storing the image frame sequence based on the target differential block comprises: generating a differential image information based on a position of an area of the target differential block within the target image frame and a size of the area; and storing the image frame sequence based on the differential image information and the reference image frame.

Specifically, once the differential operation for all pixels are completed, the acquisition of the differential area(s) in the target image frame is also accomplished. A differential image information may be generated based on an area location and a size of the target differential block in the target image frame. Then the image frame sequence may be stored according to the differential image information and the reference image frame.

It should be understood, when the target image is rendered, the image information of the differential area may be acquired. The area location and the size of the differential area may be utilized to determine the position for rendering the image information, and then the image information of the differential area may be rendered onto the corresponding position of the reference image frame. Therefore, the target image frame may be acquired.

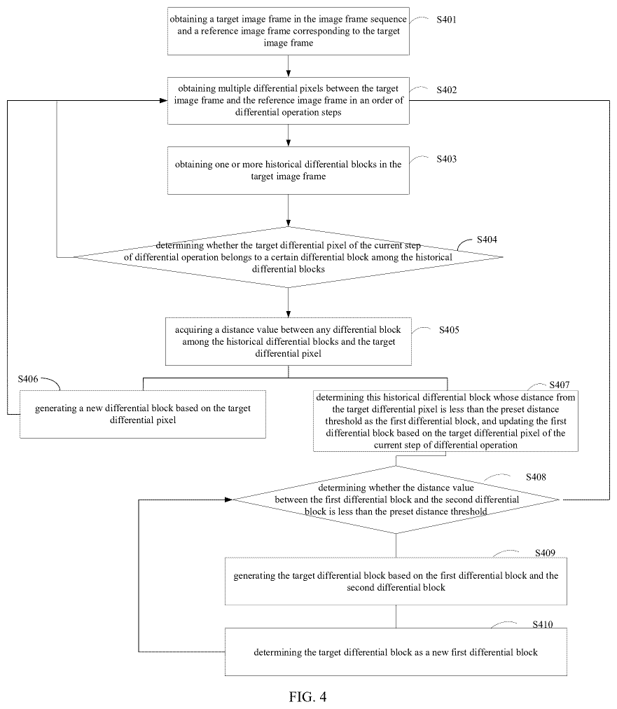

In the following section, the above method for processing the image frame sequence will be further explained with reference to a specific application scenario. As shown in FIG. 4, the method for processing an image frame sequence includes:

S401: obtaining a target image frame in the image frame sequence and a reference image frame corresponding to the target image frame;

S402: obtaining multiple differential pixels between the target image frame and the reference image frame in an order of differential operation steps;

S403: obtaining one or more historical differential blocks in the target image frame;

S404: determining whether the target differential pixel of the current step of differential operation belongs to a certain differential block among the historical differential blocks. If yes, the operation S402 is performed; otherwise, the operation S405 is performed.

S405: acquiring a distance value between any differential block among the historical differential blocks and the target differential pixel. If the distance value between each differential block among the historical differential blocks and the target differential pixel is larger than or equal to a preset distance threshold, the operation S406 is performed. If there exists a differential block whose distance value from the target differential pixel is less than the preset distance threshold, the operation S407 is performed.

S406: generating a new differential block based on the target differential pixel, and proceeding to the operation S402.

S407: determining this historical differential block whose distance from the target differential pixel is less than the preset distance threshold as the first differential block, and updating the first differential block based on the target differential pixel of the current step of differential operation.

S408: determining whether the distance value between the first differential block and the second differential block is less than the preset distance threshold. If yes, the operation S409 is performed; otherwise, the operation S402 is performed.

Herein, the second differential block is a differential block in the target image frame different from the first differential block.

S409: generating the target differential block based on the first differential block and the second differential block.

S410, determining the target differential block as a new first differential block, and proceeding to operation S480.

When the target differential pixel of the current step of the differential operation is a last differential pixel, storing the image frame sequence based on the target differential block.

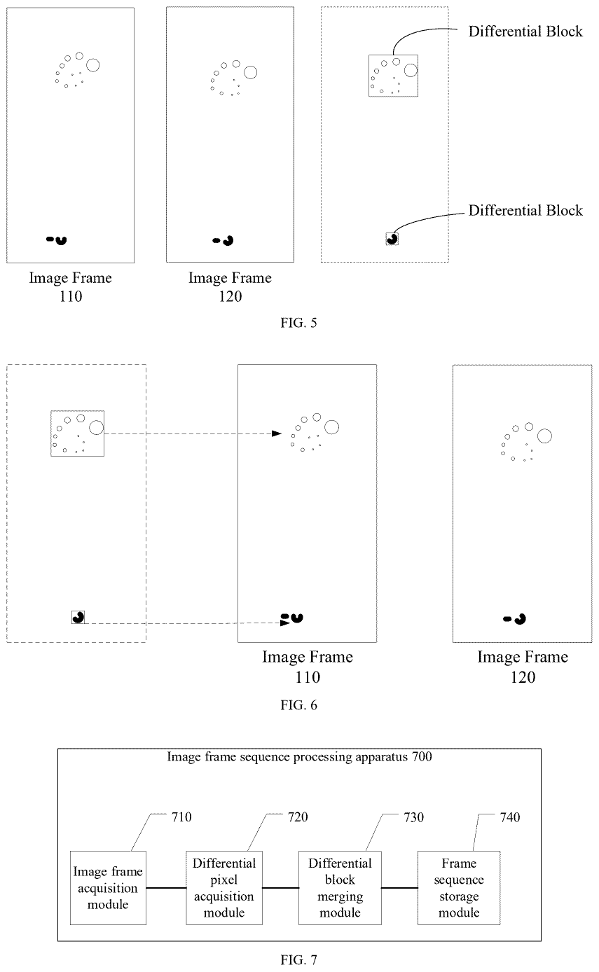

The image frame 110 and the image frame 120 as shown in FIG. 1 may be taken as an example. The differential operation may be performed for the image frame 110 and the image frame 120 based on the above method for process image frame sequence. FIG. 5 shows an example of the acquired differential blocks. It can be seen, the number of blocks may be effectively controlled. For example, if the method is applied for the starlight animation as mentioned above, a large number of tiny differential areas may be merged into one area. Another benefit brought by the image frame sequence processing method is that when rendering the image frame 120, the number of differential blocks is reduced, which may significantly decreases the decoding and rendering instructions called during the drawing process, as shown in FIG. 6. Therefore, the rendering efficiency may be greatly improved.

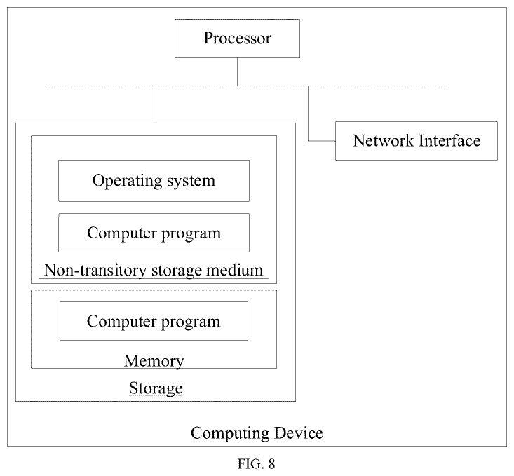

In order to better implement the image frame sequence processing method provided by embodiment of the present disclosure, the present disclosure further provides an apparatus for processing image frame sequence. As shown in FIG. 7, the apparatus for processing image frame sequence includes:

An image frame acquisition module 710, configured to obtain a target image frame in the image frame sequence and a reference image frame corresponding to the target image frame;

A differential pixel acquisition module 720, configured to obtain a plurality of differential pixels between the target image frame and the reference image frame in an order of differential operation steps, and update a first differential block in the target image frame based on a target differential pixel in a current step of the differential operation;

A differential block merging module 730, configured to generate a target differential block based on the first differential block and a second differential block when a distance value between the first differential block and the second differential block is less than a preset distance threshold, wherein the second differential block is a differential block different from the first differential block in the target image frame; and A frame sequence storage module 740, configured to store the image frame sequence based on the target differential block when the target differential pixel of the current step of the differential operation is a last differential pixel.

In some embodiments of the present disclosure, the differential pixel acquisition module is further configured to obtain one or more historical differential blocks in the target image frame; when the target differential pixel does not belong to any of the one or more historical differential blocks, determine one of the one or more historical differential blocks whose distance from the target differential pixel is less than a preset distance threshold as the first differential block; and

In some embodiments of the present disclosure, the differential pixel acquisition module is further configured to: when the target differential pixel does not belong to any of the one or more historical differential blocks and a distance of each of the one or more historical blocks from the target differential pixel is larger than the preset distance threshold, generate the first differential block based on the target differential pixel.

In some embodiments of the present disclosure, the differential block merging module is further configured to: proceed to the generating the target differential block based on the first differential block and the second differential block when the distance value between the first differential block and the second differential block is less than the preset distance threshold.

In some embodiments of the present disclosure, the differential pixel acquisition module is configured to: obtain a first pixel data of the target image frame at a current coordinate and a second pixel data of the reference image frame at the current coordinate in the order of the differential operation steps; and when the first pixel data and the second pixel data are different, determine a pixel at the current coordinate as a differential pixel.

In some embodiments of the present disclosure, the differential pixel acquisition module is configured to: obtain a first pixel data of the target image frame at a current coordinate and a second pixel data of the reference image frame at the current coordinate in the order of the differential operation steps; and when one of the first transparency parameter and the second transparency parameter is greater than a preset transparency parameter and another one of the first transparency parameter and the second transparency parameter is less than or equal to the preset transparency parameter, determine a pixel at the current coordinate as a differential pixel; when both the first transparency parameter and the second transparency parameter are greater than the preset transparency parameter, obtain a first RGB parameter of the target image frame at the current coordinate and a second RGB parameter of the reference image frame at the current coordinate; responsive to the first RGB parameter and the second RGB parameter being different, determine a pixel at the current coordinate as a differential pixel.

In some embodiments of the present disclosure, the image frame acquisition module is further configured to: obtain an image width and an image height of the image frame sequence; determine a maximum value between the image width and the image height; and determine the preset distance threshold based on the maximum value.

In some embodiments of the present disclosure, the frame sequence storage module is configured to: generate a differential image information based on a position of an area of the target differential block within the target image frame and a size of the area; and store the image frame sequence based on the differential image information and the reference image frame.

The specific details regarding the image frame sequence processing device can refer to the limitations of the image frame sequence processing method mentioned above, which will not be reiterated here. All the modules within the aforementioned image frame sequence processing device can be implemented entirely or partially through software, hardware, or a combination thereof. The aforementioned modules can be embedded in or independent from the processor within a computer device in hardware form, or stored in the memory of a computer device in software form, to facilitate the processor in executing the operations corresponding to each module.

In some embodiments of this application, the image frame sequence processing apparatus 700 can be implemented in the form of a computer program, which can run on a computer device as shown in FIG. 8. The memory of the computer device can store various program modules that constitute the image frame sequence processing apparatus 700, such as the image frame acquisition module 710, differential pixel acquisition module 720, differential block merging module 730, and frame sequence storage module 740 shown in FIG. 7. The computer program, constituted by various program modules, enables the processor to execute the steps in the image frame sequence processing method of various embodiments described in this specification.

For example, the computer device shown in FIG. 8 can execute step S210 through the image frame acquisition module 710 in the image frame sequence processing apparatus 700 shown in FIG. 7. The computer device can execute step S220 through the differential pixel acquisition module 720. The computer device can execute step S230 through the differential block merging module 730. The computer device can execute step S240 through the frame sequence storage module 740. This computer device includes a processor, memory, and network interface connected via a system bus. The processor of the computer device is used to provide computing and control capabilities. The memory of the computer device includes non-volatile storage media and internal memory. The non-volatile storage media store the operating system and computer program. The internal memory provides an environment for the operation of the operating system and computer program in the non-volatile storage media. The network interface of the computer device is used for communication with external computer devices via network connections. The computer program is executed by the processor to implement an image frame sequence processing method.

Those skilled in the art can understand that the structure shown in FIG. 8 is just a block diagram of some of the structures related to the application scheme and does not constitute a limitation on the computer device applied to the application scheme. The specific computer device can include more or fewer components than shown in the figure, or a combination of certain components, or have a different component arrangement.

In some embodiments of this application, a computer device is provided, including one or more processors; memory; and one or more applications, where the one or more applications are stored in the memory and are configured to be executed by the processor to perform the steps of the above image frame sequence processing method. The steps of the image frame sequence processing method here can be the steps of the image frame sequence processing method in the above embodiments.

In some embodiments of this application, a computer-readable storage medium is provided, which stores a computer program. When the computer program is loaded by the processor, the processor executes the steps of the above image frame sequence processing method. The steps of the image frame sequence processing method here can be the steps of the image frame sequence processing method in the above embodiments.

Those of ordinary skill in the art can understand that all or part of the processes in the above embodiments can be completed by instructing the relevant hardware through a computer program. The computer program can be stored in a non-volatile computer-readable storage medium. When the computer program is executed, it can include the processes of the embodiments of the above methods. Any reference in the embodiments provided in this application to memory, storage, databases, or other media can include at least one of non-volatile and volatile memory. Non-volatile memory can include read-only memory (ROM), magnetic tape, floppy disk, flash memory, optical storage, etc. Volatile memory can include random access memory (RAM) or external high-speed cache memory. For illustrative and not limiting purposes, RAM can take many forms, such as static random access memory (SRAM) or dynamic random access memory (DRAM), etc.

The technical features of the above embodiments can be combined in any way. To make the description concise, not all possible combinations of the technical features in the above embodiments have been described. However, as long as these technical feature combinations do not contradict each other, they should all be considered within the scope of this specification.

The above provides a detailed introduction to an image frame sequence processing method, device, computer device, and storage medium provided in the embodiments of this application. This document has used specific examples to explain the principles and implementation methods of this application. The above embodiment descriptions are only used to help understand the methods of this application and its core ideas; at the same time, for those skilled in the art, according to the ideas of this application, there will be changes in specific implementation methods and application scopes. In summary, the content of this specification should not be interpreted as limiting this application.

1. A method for processing an image frame sequence, comprising:
obtaining a target image frame in the image frame sequence and a reference image frame corresponding to the target image frame;
obtaining a plurality of differential pixels between the target image frame and the reference image frame in an order of differential operation steps;
updating a first differential block in the target image frame based on a target differential pixel in a current step of the differential operation;
generating a target differential block based on the first differential block and a second differential block when a distance value between the first differential block and the second differential block is less than a preset distance threshold, wherein the second differential block is a differential block different from the first differential block in the target image frame; and
when the target differential pixel of the current step of the differential operation is a last differential pixel, storing the image frame sequence based on the target differential block.

2. The method of claim 1, wherein the updating the first differential block in the target image frame based on the target differential pixel in the current step of the differential operation comprises:
obtaining one or more historical differential blocks in the target image frame;
when the target differential pixel does not belong to any of the one or more historical differential blocks, determining one of the one or more historical differential blocks whose distance from the target differential pixel is less than a preset distance threshold as the first differential block; and updating the first differential block based on the target differential pixel in the current step of the differential operation.

3. The method of claim 2, after the obtaining the one or more historical differential blocks in the target image frame, further comprising:
when the target differential pixel does not belong to any of the one or more historical differential blocks and a distance of each of the one or more historical blocks from the target differential pixel is larger than the preset distance threshold, generating the first differential block based on the target differential pixel.

4. The method of claim 1, after the generating the target differential block based on the first differential block and the second differential block, further comprising:
updating the first differential block with the target differential block; and proceeding to the generating the target differential block based on the first differential block and the second differential block when the distance value between the first differential block and the second differential block is less than the preset distance threshold.

5. The method of claim 1, wherein the obtaining the plurality of differential pixels between the target image frame and the reference image frame in the order of differential operation steps comprises:
obtaining a first pixel data of the target image frame at a current coordinate and a second pixel data of the reference image frame at the current coordinate in the order of the differential operation steps;
when the first pixel data and the second pixel data are different, determining a pixel at the current coordinate as a differential pixel.

6. The method of claim 1, wherein the obtaining the plurality of differential pixels between the target image frame and the reference image frame in the order of differential operation steps comprises:
obtaining a first transparency parameter of the target image frame at a current coordinate and a second transparency parameter of the reference image frame at the current coordinate in the order of the differential operation steps;
when one of the first transparency parameter and the second transparency parameter is greater than a preset transparency parameter and another one of the first transparency parameter and the second transparency parameter is less than or equal to the preset transparency parameter, determining a pixel at the current coordinate as a differential pixel;
when both the first transparency parameter and the second transparency parameter are greater than the preset transparency parameter, obtaining a first RGB parameter of the target image frame at the current coordinate and a second RGB parameter of the reference image frame at the current coordinate;
responsive to the first RGB parameter and the second RGB parameter being different, determining a pixel at the current coordinate as a differential pixel.

7. The method of claim 1, before the obtaining the target image frame in the image frame sequence and the reference image frame corresponding to the target image frame, further comprising:
obtaining an image width and an image height of the image frame sequence;
determining a maximum value between the image width and the image height; and
determining the preset distance threshold based on the maximum value.

8. The method of claim 1, wherein the storing the image frame sequence based on the target differential block comprises:
generating a differential image information based on a position of an area of the target differential block within the target image frame and a size of the area; and
storing the image frame sequence based on the differential image information and the reference image frame

9. The method of claim 1, wherein the target image frame is an image frame to be processed in the image frame sequence; wherein the reference image frame is an image frame adjacent to and immediately preceding the target image frame in time series.

10. The method of claim 2, further comprising:
when the target differential pixel is located within a certain differential block of the one or more historical differential blocks, determining the certain differential block as the first differential block corresponding to the target differential pixel of the current step of the differential operation.

11. The method of claim 7, wherein the determining the preset distance threshold based on the maximum value comprises:
dividing the maximum value by n to obtain the preset distance threshold; wherein n is an integer ranging from 5 to 10.

12. The method of claim 1, wherein the distance value between the first differential block and the second differential block is determined by:
obtaining a center coordinate of the first differential block, and obtaining a center coordinate of the second differential block;
determining the distance value between the first differential block and the second differential block based on a distance between the center coordinate of the first differential block and the center coordinate of the second differential block.

13. The method of claim 1, wherein the distance value between the first differential block and the second differential block is determined by:
obtaining a shortest distance value between a boundary of the first differential block and a boundary of the second differential block; and
determining the shortest distance value as the distance value between the first differential block and the second differential block.

14-20. (canceled)

21. A computing device, comprising: one or more processors, a memory, and one or more application programs;
wherein the one or more application programs are stored in the memory and configured to be executed by the one or more processors to perform a method for processing an image frame sequence, wherein the method comprises:
obtaining a target image frame in the image frame sequence and a reference image frame corresponding to the target image frame;
obtaining a plurality of differential pixels between the target image frame and the reference image frame in an order of differential operation steps;
updating a first differential block in the target image frame based on a target differential pixel in a current step of the differential operation;
generating a target differential block based on the first differential block and a second differential block when a distance value between the first differential block and the second differential block is less than a preset distance threshold, wherein the second differential block is a differential block different from the first differential block in the target image frame; and
when the target differential pixel of the current step of the differential operation is a last differential pixel, storing the image frame sequence based on the target differential block.

22. The computing device of claim 21, wherein the updating the first differential block in the target image frame based on the target differential pixel in the current step of the differential operation comprises:
obtaining one or more historical differential blocks in the target image frame;
when the target differential pixel does not belong to any of the one or more historical differential blocks, determining one of the one or more historical differential blocks whose distance from the target differential pixel is less than a preset distance threshold as the first differential block; and updating the first differential block based on the target differential pixel in the current step of the differential operation.

23. The computing device of claim 21, wherein after the obtaining the one or more historical differential blocks in the target image frame, the method further comprises:
when the target differential pixel does not belong to any of the one or more historical differential blocks and a distance of each of the one or more historical blocks from the target differential pixel is larger than the preset distance threshold, generating the first differential block based on the target differential pixel.

24. The computing device of claim 21, wherein the obtaining the plurality of differential pixels between the target image frame and the reference image frame in the order of differential operation steps comprises:
obtaining a first pixel data of the target image frame at a current coordinate and a second pixel data of the reference image frame at the current coordinate in the order of the differential operation steps;
when the first pixel data and the second pixel data are different, determining a pixel at the current coordinate as a differential pixel.

25. The computing device of claim 21, wherein the obtaining the plurality of differential pixels between the target image frame and the reference image frame in the order of differential operation steps comprises:
obtaining a first transparency parameter of the target image frame at a current coordinate and a second transparency parameter of the reference image frame at the current coordinate in the order of the differential operation steps;
when one of the first transparency parameter and the second transparency parameter is greater than a preset transparency parameter and another one of the first transparency parameter and the second transparency parameter is less than or equal to the preset transparency parameter, determining a pixel at the current coordinate as a differential pixel;
when both the first transparency parameter and the second transparency parameter are greater than the preset transparency parameter, obtaining a first RGB parameter of the target image frame at the current coordinate and a second RGB parameter of the reference image frame at the current coordinate;
responsive to the first RGB parameter and the second RGB parameter being different, determining a pixel at the current coordinate as a differential pixel.

26. The computing device of claim 21, wherein before the obtaining the target image frame in the image frame sequence and the reference image frame corresponding to the target image frame, the method further comprises:
obtaining an image width and an image height of the image frame sequence;
determining a maximum value between the image width and the image height; and
determining the preset distance threshold based on the maximum value.

27. A non-transitory computer readable storage medium, stored with a computer program; wherein the computer program is executed by a processor to implement a method for processing the image frame sequence, wherein the method comprises:
obtaining a target image frame in the image frame sequence and a reference image frame corresponding to the target image frame;
obtaining a plurality of differential pixels between the target image frame and the reference image frame in an order of differential operation steps;
updating a first differential block in the target image frame based on a target differential pixel in a current step of the differential operation;
generating a target differential block based on the first differential block and a second differential block when a distance value between the first differential block and the second differential block is less than a preset distance threshold, wherein the second differential block is a differential block different from the first differential block in the target image frame; and
when the target differential pixel of the current step of the differential operation is a last differential pixel, storing the image frame sequence based on the target differential block.
